(19) United States
(12) Patent Application Publication
(10) Pub. No.: US 2020/0262131 A1
(43) Pub. Date: Aug. 20, 2020

(54) METHOD FOR FORMING A VACUUM BAGGING FILM COMPRISING THE FORMATION OF RIBS BY BUCKLING OF THE FILM

(71) Applicant: Airbus Operations (S.A.S.), Toulouse (FR)

(72) Inventors: Maxime Percevault, Nantes (FR); Bertrand Duthille, Reze (FR)

(21) Appl. No.: 16/792,450

(22) Filed: Feb. 17, 2020

(30) Foreign Application Priority Data
Feb. 19, 2019 (FR) 1901657

(51) Int. Cl. B29C 51/10; B29C 65/70

(52) U.S. Cl. CPC B29C 51/10; B29L 2007/008; B29C 65/70

(57) ABSTRACT

A simple and inexpensive method for forming a vacuum bagging film includes formation of ribs, each by a sequence including placement of pressing members on the film, on either side of a region of the film, then translational displacement of at least a second of the pressing members, to reduce a distance mutually separating the pressing members, while exerting respective pressures on the film by each of the pressing members such that the pressing member in translation drives the film with it by friction, whereby the region of the film is deformed by buckling in forming the rib, then the stopping of the translational displacement, and then removal of the pressing members.

### CROSS-REFERENCE TO RELATED APPLICATION

This application claims the benefit of and priority to French patent application number 19 01657 filed on Feb. 19, 2019, the entire disclosure of which is incorporated by reference herein.

### TECHNICAL FIELD

The disclosure herein relates to a method for forming a vacuum bagging film suited to the manufacturing of a component made of composite material by vacuum baking.

### BACKGROUND

Vacuum bagging is a technique that is widely used, particularly in the aeronautical industry, to manufacture components made of composite materials formed by reinforcing fibers embedded in a hardened resin.

Indeed, efforts are made in the field of aircraft construction to employ such components, notably as structural elements.

Vacuum bagging consists in arranging and sealing a film on a preform before the latter is baked. The preform can be positioned on a molding tool. The preform can, for example, be in the form of a fabric of reinforcing fibers pre-impregnated with a hardenable resin, possibly laminated, or be a dry fibrous preform intended to be subsequently embedded in a hardenable resin, for example by a resin infusion technique.

The vacuum bagging techniques have nevertheless proved difficult to use in the context of the production of bulky or long components such as the components intended to form the wings of aircrafts, which can comprise structural sections more than 10 meters long.

Furthermore, in the case of parts comprising a face provided with ribs or relief structures, such as self-stiffened aircraft panels, the vacuum bagging film must generally be positioned on the face provided with the ribs, which complicates the issue of obtaining a fitted covering of the face by the film.

To remedy these problems, the document EP3115184A1 has proposed a vacuum bagging system comprising a vacuum bagging film thermoformed in an outer form of the component to be manufactured, the latter being, for example, a self-stiffened panel.

A method proposed in this document for thermoforming the vacuum bagging film relies on the use of vacuum-forming and heating modules each configured to cover a stiffening rib (see in particular FIGS. 3 and 4 of the document EP3115184A1 mentioned above), which represents an implementation cost which remains relatively high.

Other methods proposed in this document for thermoforming the vacuum bagging film rely on the use, facing the vacuum bagging film, of an air blowing device configured to apply an aerodynamic pressure to the film, during thermoforming thereof (see in particular FIGS. 1 and 2 of the document EP3115184A1 mentioned above). When obtaining a film of large dimensions is desired, such a device does however prove costly to produce and impractical to use.

### SUMMARY

An aim of the disclosure herein is in particular to provide a simple, economical and effective solution to these problems.

To this end, it proposes a method for forming a vacuum bagging film, comprising:

a) deposition of a vacuum bagging film on a support, and provision of a first pressing member and of a second pressing member; then

b) formation of a plurality of ribs in the vacuum bagging film, each rib being produced by a sequence comprising:

b1) placement of the first pressing member and of the second pressing member on the vacuum bagging film, on either side of a region of the vacuum bagging film intended to form the rib; then

b3) translational displacement of at least one of the first and second pressing members, so as to reduce a distance separating the first pressing member from the second pressing member, while exerting respective pressures on the vacuum bagging film by each of the first and second pressing members so that the at least one of the first and second pressing members drives the vacuum bagging film with it by friction, whereby the region of the vacuum bagging film is deformed by buckling in forming the rib; then

b4) stopping of the translational displacement then removal of the first pressing member and of the second pressing member.

The disclosure herein thus offers a simple and inexpensive method that makes it possible to form a vacuum bagging film.

According to other advantageous aspects of the disclosure herein, the forming method has one or more of the following features, taken alone or according to all technically possible combinations:
the translational displacement consists of or comprises a displacement of the first pressing member and of a holding in position of the second pressing member;
in any iteration of the sequence of steps after the first iteration thereof, the second pressing member is positioned, in the step b1, at a location previously occupied by the first pressing member in the step b4 of the preceding iteration of the sequence of steps, whereby an extent of the second pressing member, in a direction of the translational displacement, is equal to an inter-rib distance of the vacuum bagging film;
in at least one iteration of the sequence of steps after the first iteration thereof, the step b1 comprises an adjustment of the extent of the second pressing member, in the direction of the translational displacement, whereby the inter-rib distance of the vacuum bagging film is variable;
the support has an anti-friction coating;
the support is a heating support;
the sequence of steps comprises a step b2 of heating of the region of the vacuum bagging film to a thermoforming temperature thereof, implemented between the step b1 and the step b3;
each of the first and second pressing members incorporates a respective heating device.

The disclosure herein relates also to a method for manufacturing a component made of composite material by vacuum baking, comprising:

A) preparation of a preform of the component made of composite material, having a side provided with ribs;

B) forming of at least one vacuum bagging film by a forming method of the type described above, such that the vacuum bagging film has ribs corresponding to the ribs of the preform;

C) placement of the at least one vacuum bagging film on the side of the preform provided with the ribs of the preform, such that each rib of the vacuum bagging film covers a corresponding rib of the preform;

D) vacuum baking of the preform;

E) obtaining of the component made of composite material.

According to other advantageous aspects of the disclosure herein, the method for manufacturing a component made of composite material has one or more of the following features, taken alone or according to all technically possible combinations.
the preform prepared in the step A comprises a panel portion, and portions of stiffeners arranged on the panel portion and forming the ribs of the preform and the step D is a step of joint baking of the panel portion and of the portions of stiffeners, such that the component obtained in the step E is a self-stiffened panel;
the preform prepared in the step A is formed by reinforcing fibers pre-impregnated with a hardenable resin;
the step B comprises the forming of several vacuum bagging films by a method of the type described above, then the tight joining of the vacuum bagging films to one another to form an assembly of vacuum bagging films having ribs, and the step C consists of or comprises the placement of the assembly of vacuum bagging films on the side of the preform provided with the ribs of the preform, such that each rib of the assembly of vacuum bagging films covers a corresponding rib of the preform.

### BRIEF DESCRIPTION OF THE DRAWINGS

The disclosure herein will be better understood, and other details, advantages and features thereof will become apparent on reading the following description given as a nonlimiting example and with reference to the attached drawings in which:

Figures (FIGS. 1-5 are schematic side views of a support, of a vacuum bagging film, and of pressing members, and respectively illustrate successive steps of a method for forming the vacuum bagging film, according to a preferred embodiment of the disclosure herein;

FIG. 6 is a schematic section view of the vacuum bagging film, obtained at the end of the method illustrated by FIGS. 1 through 5;

FIG. 7A is a schematic perspective view of an assembly of vacuum bagging films each produced by the method illustrated by FIGS. 1 through 5;

FIG. 7B is a schematic perspective view of another assembly of vacuum bagging films each produced by the method illustrated by FIGS. 1 through 5;

FIG. 8 is a schematic diagram of a method for manufacturing a component made of composite material by vacuum baking, by a vacuum bagging film produced by the method illustrated by FIGS. 1 through 5;

FIG. 9 is a schematic section view of the component made of composite material during the implementation of the method of FIG. 8;

FIG. 10 is a schematic section view of a first configuration of a second pressing member used in a method according to an embodiment of the disclosure herein;

FIG. 11 is a schematic section view of a second configuration of the second pressing member of FIG. 10.

Throughout these figures, identical references can denote identical or similar elements.

### DETAILED DESCRIPTION

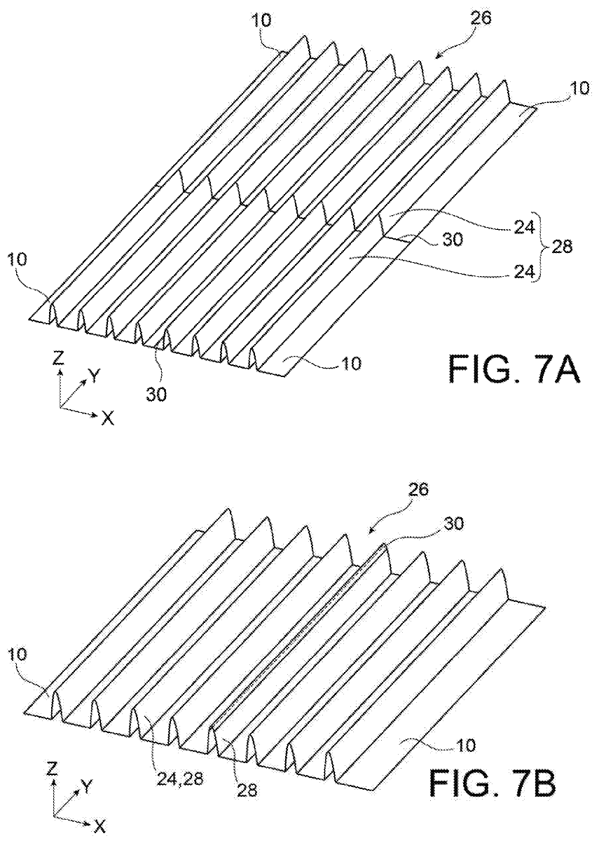

FIGS. 1 through 5 schematically illustrate successive steps of a method for forming a vacuum bagging film according to a preferred embodiment of the disclosure herein, corresponding to the step B of the diagram of FIG. 8. Such a film is intended for the production of a component made of composite material by vacuum baking, as will appear more clearly hereinbelow.

The method according to the disclosure herein is more particularly intended for the production of a film capable of covering a ribbed face of such a component, the component being, for example, a self-stiffened panel.

The method comprises, first of all, a step comprising the deposition of a vacuum bagging film 10 on a support 12, and the provision of a first pressing member 14 and of a second pressing member 16.

In the present description, for convenience, an orthonormal reference frame XYZ is defined, in which the direction Z is locally orthogonal to the support 12 and corresponds to the heightwise direction when the support is arranged horizontally (such an orientation not however being necessary to the implementation of the method in its more general definition).

The deposition of the film 10 is for example done by extending the film from a roll, or by directly extruding the film above the support 12.

The vacuum bagging film 10 is for example produced in a polymer material, for example of polyamide or polyester type, co-extruded with a fluoropolymer of ethylene tetrafluoroethylene (ETFE) or polytetrafluoroethylene (PTFE) type. The film 10 thus has anti-adhesive properties, at least on one face 18, allowing the mold stripping of the component at the end of the vacuum baking thereof.

In other embodiments, the film 10 is made of polyamide or polyester that has, for example, undergone a physical-chemical treatment to confer on the film 10 the abovementioned anti-adhesive properties.

The film can possibly be multilayer and can comprise, in the different layers, materials having different properties, such as vacuum sealing properties, adhesive properties, or, on the contrary, anti-adhesive properties.

In particular, the face 18 of the vacuum bagging film 10 is disposed in contact with the support 12, so as to facilitate a slipping of the film on the support.

The pressing members 14, 16 are elements that each has a respective bearing face 14A, 16A capable of exerting a friction force on the face 20 of the film disposed on the side opposite the face 18 in contact with the support.

These pressing members 14, 16 are for example of generally elongate form (in the direction Y in the figures).

The support 12 has a flat bearing surface on which the film 10 rests, and the respective bearing face of each of the pressing members 14, 16 is also flat. The pressing members thus for example have a section of parallelogram form (in planes XZ), for example of rectangular form.

The method then comprises a step b comprising the formation of ribs in the vacuum bagging film, by a sequence of steps b1 to b4 implemented for each rib to be produced, that is to say as many times as there are ribs to be produced in the film.

The step b1, illustrated by FIG. 2, comprises the placement of the first pressing member 14 and of the second pressing member 16 on the vacuum bagging film 10, on either side of a region 22 of the vacuum bagging film intended to form the rib concerned. The pressing members 14, 16 are disposed such that their respective bearing faces 14A, 16A rest on the vacuum bagging film 10. The spacing D between the pressing members 14, 16 is determined as a function of the desired height of the rib and of the more or less abrupt nature thereof, which are parameters dependent on the form of a rib of the component to be manufactured.

In some embodiments of the disclosure herein, the sequence of steps then comprises a step b2 of heating of the region 22 of the vacuum bagging film to a thermoforming temperature of the material of which the film is composed.

To this end, the support 12 and/or the pressing members 14, 16 incorporate respective heating devices 23, such as electrical resistors powered by an electrical energy source (visible in FIG. 1 only).

The sequence of steps is continued with a step b3, illustrated by FIG. 3, which comprises the translational displacement, in the direction X, of at least one of the first and second pressing members, so as to reduce the distance D′ separating the first pressing member 14 from the second pressing member 16.

During this process, respective pressures are exerted on the vacuum bagging film by each of the first and second pressing members, such that the pressing member which is displaced, or each pressing member which is displaced, drives the vacuum bagging film 10 with by virtue of the friction forces being exerted between the respective bearing faces 14A, 16A of the pressing members and the vacuum bagging film 10.

Because of this, the region 22 of the vacuum bagging film is deformed by buckling and thus forms the rib 24 concerned.

In the preferential example illustrated, the translational displacement T concerns the first pressing member 14, whereas the second pressing member 16 is kept immobile. To this end, the pressure P2 exerted on the second pressing member is of a level greater than the level of the pressure P1 exerted on the first pressing member.

The sequence of steps is continued with a step b4, illustrated by FIG. 4, which comprises the stopping of the translational displacement mentioned above, then the removal of the pressing members 14 and 16.

If appropriate, the cooling of the region 22 of the vacuum bagging film 10 provokes the hardening thereof and therefore the lasting maintenance of the form of the rib previously produced.

The sequence of steps b1 to b4 is repeated for each of the ribs to be formed.

For each of the ribs 24, the sequence of steps is preferably implemented so that the top of the rib is rounded.

Moreover, the second pressing member 16 is advantageously used as spacer.

To this end, in any iteration of the sequence of steps b1-b4 after the first iteration of this sequence of steps, the second pressing member 16 is positioned, in the step b1, at a location previously occupied by the first pressing member in the step b4 of the preceding iteration of the sequence of steps b1-b4, as FIG. 5 illustrates. Thus, the extent E of the second pressing member 16 in the direction X of the translational displacement defines an inter-rib distance of the vacuum bagging film.

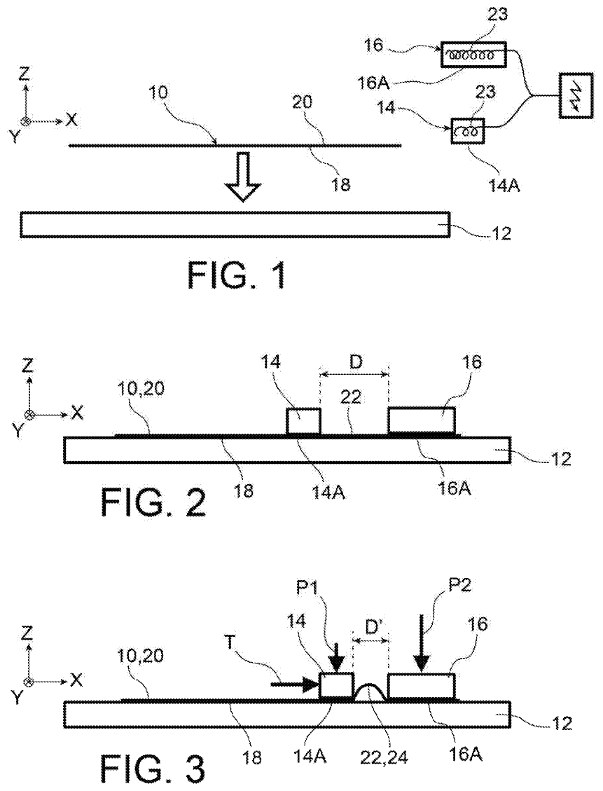

FIG. 6 illustrates the vacuum bagging film 10 obtained at the end of the above method, provided with several parallel ribs 24 formed at regular intervals.

In some embodiments of the disclosure herein, the step b2 is omitted and the method does not include any step of heating of the vacuum bagging film 10. In some cases, the mechanical properties of the film 10, notably the rigidity thereof, in fact allow for a cold forming thereof. That is for example the case when the film 10 has a thickness allowing the cold deformation of the film while conferring on the film a sufficient rigidity for the film to retain its form at the end of the method.

In other embodiments of the disclosure herein, the sequence of steps b1-b4 does not include the step b2 but the method comprises a subsequent step of heating and then of cooling of the vacuum bagging film 10, implemented after all of the ribs 24 have been formed by the sequence of steps b1-b3-b4 described above. Such a step of heating and then of cooling makes it possible to set the form of the ribs 24 and therefore ensure that the film 10 then retains its form. Moreover, in some embodiments of the disclosure herein, the second pressing member 16 has an adjustable extent E.

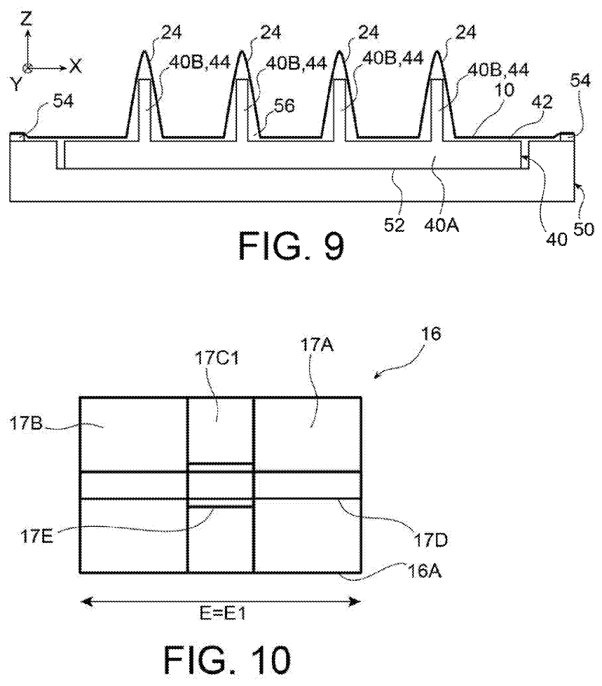

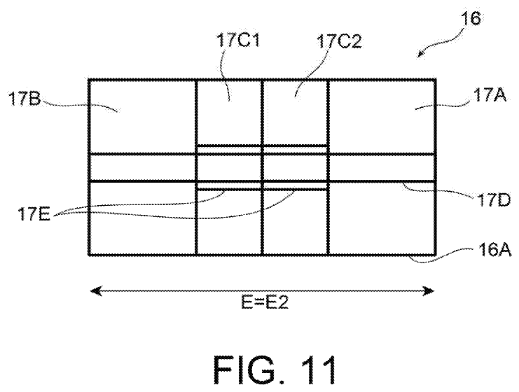

To this end, referring to FIGS. 10 and 11, the second pressing member 16 is for example composed of two end blocks 17A, 17B, forming opposite ends of the second pressing member 16, and of a variable number of intermediate blocks 17C1, 17C2. The blocks of which the second pressing member 16 are composed are for example secured to one another by one or more bolts 17D. In the example illustrated, each bolt 17D extends with play across a corresponding bore 17E of each intermediate block.

Thus, in its configuration of FIG. 10, the second pressing member 16 comprises a single intermediate block 17C1 and has an extent E equal to a first value E1, whereas, in its configuration of FIG. 11, the second pressing member 16 comprises two intermediate blocks 17C1 and 17C2 and thus has an extent E equal to a second value E2 greater than the first value E1.

As a variant, the second pressing member 16 is for example composed simply of the two end blocks 17A, 17B, in which case the latter are linked to one another by a variable length mechanism, for example a mechanism of screw-nut type.

In these embodiments, in at least one iteration of the sequence of steps b1-b4 after the first iteration thereof, the step b1 also comprises an adjustment of the extent E of the second pressing member, in the direction X of the abovementioned translational displacement.

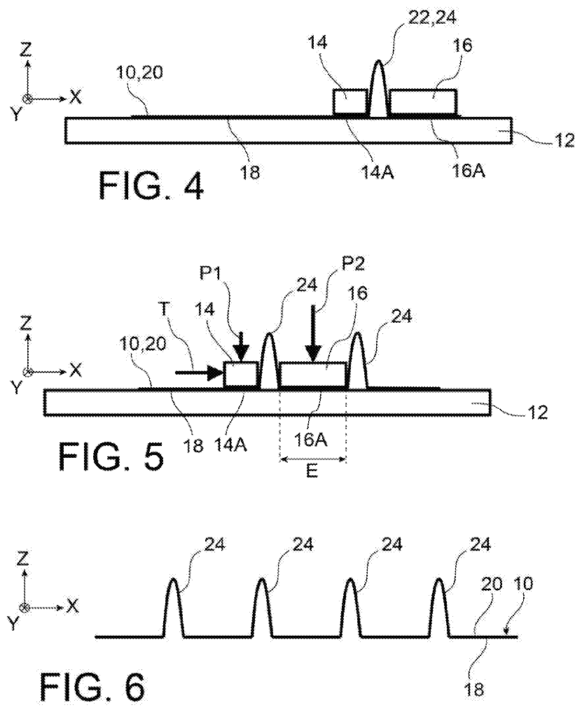

The vacuum bagging film 10 thus has an inter-rib distance that is variable. Depending on the extent of the component to be manufactured, it may be advantageous to produce several vacuum bagging films 10 by the method described above, then to tightly join the vacuum bagging films 10 to one another to form an assembly of vacuum bagging films 26 having ribs 28, as illustrated in FIG. 7A. In such an assembly, the width of which reaches 20 meters for example, each rib 28 can correspond to a rib 24 of a film 10 of which the assembly 26 is composed or result from the alignment of respective ribs 24 of several of the films 10 of which the assembly 26 is composed. The joins 30 can be produced for example by known bonding or welding techniques.

FIG. 7B illustrates such an assembly 26 of several vacuum bagging films 10 in a particularly advantageous embodiment of the disclosure herein, in which the joins 30 between the films 10 are situated at respective peaks of ribs 28 of the assembly. Such an assembly makes it possible in particular to best avoid the contact between the join zones 30 and the component before the baking thereof, which is advantageous in as much as the joins 30 in some cases result in a local overthickness of the assembly 26 that is likely to mark the component. In the example illustrated, each join 30 is produced by mastic interposed between two consecutive films 10 such that the mastic constitutes the top of the corresponding rib 28.

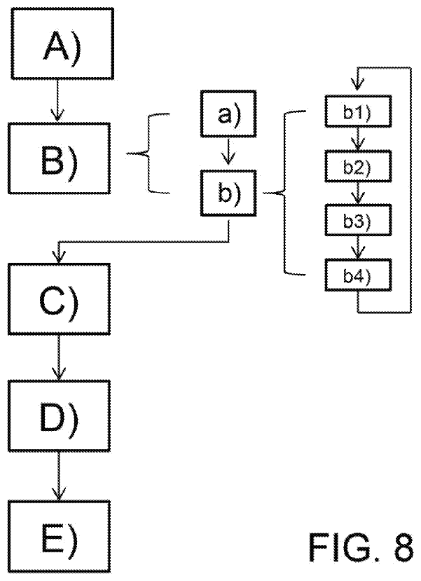

Referring to FIGS. 8 and 9, a method for manufacturing a component made of composite material by vacuum baking comprises, according to the disclosure herein, steps of:
A) preparation of a preform 40 of the component made of composite material, having a side 42 provided with ribs 44;
B) forming of at least one vacuum bagging film 10 by a method of the type described above, such that the vacuum bagging film 10 has ribs 24 corresponding to the ribs 44 of the preform; possibly formation of an assembly of vacuum bagging films from several vacuum bagging films thus formed, as explained above;
C) placement of the vacuum bagging film 10, or of the assembly of vacuum bagging films, on the side 42 of the preform provided with the ribs 44, such that each rib 24 of the vacuum bagging film 10 or of the assembly covers a corresponding rib 44 of the preform 40;
D) vacuum baking of the preform 40;
E) obtaining of the component made of composite material.
More specifically, referring to FIG. 9, the step A comprises the deposition of the preform 40 on a molding tool 50.

The preform 40 can be in the form of a fabric of reinforcing fibers pre-impregnated with a hardenable resin, possibly laminated, or be a dry fibrous preform intended to be subsequently embedded in a hardenable resin, for example by a resin infusion technique.

The preform 40 comprises, for example, a panel portion 40A and portions of stiffeners 40B arranged on the panel portion 40A, on the abovementioned side 42 of the preform, that is to say on the side opposite the molding tool 50. In this case, the portions of stiffeners 40B form the abovementioned ribs 44 of the preform 40.

The molding tool 50 is configured to support the preform 40 and can comprise a mold or a profile section to confer or maintain a desired form on the side 52 of the preform which rests on the molding tool 40, that is to say, typically, the bottom side of the preform. The step B comprises, as indicated above, the production of a vacuum bagging film 10 or of an assembly 26 of such films, by the method described above with reference to FIGS. 1 through 7.

Still referring to FIG. 9, the step C comprises the deposition of the vacuum bagging film 10, or of the assembly of vacuum bagging films, on the side 42 of the preform 40, which is typically arranged on the top side, then the sealing of the vacuum bagging film 10, or of the assembly of vacuum bagging films, on the molding tool 50, by sealing joints 54 for example produced by bonding. At the end of the step C, the vacuum bagging film 10, or the assembly of vacuum bagging films, covers the side 42 of the preform such that the ribs 24 of the film 10 coincide with the ribs 44 of the preform 40.

At this stage, conventional accessory toolage elements (not illustrated) can be put in place on the film, notably on the ribs 24/44.

The step D comprises the formation of a partial vacuum in the space 56 formed between, on the one hand, the vacuum bagging film 10, or the assembly of vacuum bagging films, and, on the other hand, the preform 40 and the molding tool 50, culminating in the baking of the preform.

It should be understood thereby that the step D comprises, if appropriate, the infusion of resin in the case where the preform is a dry preform, and comprises, in all cases, the hardening of the resin within the space 56 in which the partial vacuum is created, culminating in the obtaining of the component made of composite material.

To this end, the step D preferably comprises a heating of the preform and of the resin. In this case, the result thereof is also a heating of the vacuum bagging film 10 or of the assembly of vacuum bagging films, which promotes a deformation of the film 10 or of the assembly of films causing the film 10 or the assembly of films to most closely cover the preform and thus best avoids the presence of air pockets in the space 56. Such a deformation of the film 10 or of the assembly of films typically comprises a stretching of the latter allowing for a fitted covering of the relief parts of the preform 40. In this case, such a stretching of the film notably allows for a fitted covering of radii connecting the stiffeners 40B to the panel portion 40A.

In the particular example where the preform 40 comprises a panel portion 40A and portions of stiffeners 40B arranged on the panel portion, the step D therefore comprises the joint baking of the different portions 40A, 40B forming the preform 40.

While at least one example embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the example embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for forming a vacuum bagging film, comprising steps of:
a) deposition of a vacuum bagging film on a support, and provision of a first pressing member and of a second pressing member; then
b) formation of a plurality of ribs in the vacuum bagging film, each rib being produced by a sequence comprising steps of:
b1) placement of the first pressing member and of the second pressing member on the vacuum bagging film, on either side of a region of the vacuum bagging film intended to form the rib; then
b3) translational displacement of at least one of the first and second pressing members, to reduce distance separating the first pressing member from the second pressing member, while exerting respective pressures on the vacuum bagging film by each of the first and second pressing members so that the at least one of the first and second pressing members drives the vacuum bagging film with it by friction, whereby the region of the vacuum bagging film is deformed by buckling in forming the rib; and then
b4) stopping of the translational displacement then removal of the first pressing member and of the second pressing member.

2. The method of claim 1, wherein the translational displacement comprises displacement of the first pressing member and holding in position of the second pressing member.

3. The method of claim 2, wherein, in an iteration of the steps after a first iteration of the steps, the second pressing member is positioned, in step b1, at a location previously occupied by the first pressing member in step b3 of a preceding iteration of the steps, whereby an extent of the second pressing member, in a direction of the translational displacement, is equal to an inter-rib distance of the vacuum bagging film.

4. The method of claim 3, wherein, in at least one iteration of the steps after the first iteration of the steps, step b1 comprises adjustment of an extent of the second pressing member, in a direction of the translational displacement, whereby the inter-rib distance of the vacuum bagging film is variable.

5. The method of claim 1, wherein the support is a heating support.

6. The method of claim 1, wherein the steps comprise a step b2 of heating of the region of the vacuum bagging film to a thermoforming temperature of the vacuum bagging film, implemented between step b1 and step b3.

7. The method of claim 6, wherein each of the first and second pressing members incorporates a respective heating device.

8. A method for manufacturing a component made of composite material by vacuum baking, comprising steps of:
a) preparation of a preform of the component made of composite material, having a side provided with ribs;
b) forming of at least one vacuum bagging film by the method of claim 1, such that the vacuum bagging film has ribs corresponding to the ribs of the preform; then
c) placement of the at least one vacuum bagging film on a side of the preform provided with the ribs of the preform, such that each rib of the vacuum bagging film covers a corresponding rib of the preform; then
d) vacuum baking of the preform; then
e) obtaining of the component made of composite material.

9. The method of claim 8, wherein the preform prepared in step a comprises a panel portion, and portions of stiffeners arranged on the panel portion and forming the ribs of the preform, and wherein step d comprises joint baking of the panel portion and of the portions of stiffeners, such that the component obtained in step e is a self-stiffened panel.

10. The method of claim 8, wherein the preform prepared in step a is formed by reinforcing fibers pre-impregnated with a hardenable resin.

11. The method of claim 8, wherein step b comprises forming of several vacuum bagging films then tight joining of the vacuum bagging films to one another to form an assembly of vacuum bagging films having ribs, and wherein the step c comprises placement of the assembly of vacuum bagging films on a side of the preform provided with the ribs of the preform, such that each rib of the assembly of vacuum bagging films covers a corresponding rib of the preform.
